(19) United States
(12) Patent Application Publication
(10) Pub. No.: US 2024/0409042 A1
(43) Pub. Date: Dec. 12, 2024

(54) EXTERNALLY THREADED PUSH-ON-POST FASTENER

(71) Applicant: GM Global Technology Operations LLC, Detroit, MI (US)

(72) Inventors: Michael A. Kardasz, Troy, MI (US); Victor Wong, Lake Orion, MI (US); Jeffrey Scott Shotwell, Clarkston, MI (US)

(21) Appl. No.: 18/332,097

(22) Filed: Jun. 9, 2023

(51) Int. Cl. B60R 13/02; F16B 5/02; F16B 5/06

(52) U.S. Cl. CPC B60R 13/0206; F16B 5/02; F16B 5/0614; B60R 11/00

(57) ABSTRACT

A push-on-post fastener includes a base section and a sleeve section connected with the base section. The sleeve section includes a central passage having an inner surface. A pin section projects outwardly from the sleeve section. The pin includes an outer annular surface section having a first diameter. The inner surface of the central passage includes a plurality of striations.

### INTRODUCTION

The subject disclosure relates to the art of fasteners and, more particularly, to an externally threaded push-on-post fastener.

Vehicles include a plethora of components. The components are joined, one to another, through a variety of fastener systems. Components that experience high stresses, such as engine components, suspension components, and the like are joined with hardened fasteners. Body components may be joined with pins, metal bolts or the like depending upon location on the vehicle. Interior trim components are often joined with clips, pins, or other fasteners designed for low stress applications.

In some cases, the component may be formed with a portion of the fastener. For example, a panel may include an opening that is machined to include internal threads or a pin that is machined to include external threads. While machining small parts may be a rather simple operation, applying threads to multiple pins projecting from a surface of a larger component is a time consuming and costly process. Accordingly, it is desirable to provide an easily produced and cost effective system for providing a threaded interface on a pin.

### SUMMARY

A push-on-post fastener, in accordance with a non-limiting example, includes a base section and a sleeve section connected with the base section. The sleeve section includes a central passage having an inner surface. A pin section projects outwardly from the sleeve section. The pin includes an outer annular surface section having a first diameter. The inner surface of the central passage includes a plurality of striations.

In addition to one or more of the features described herein the outer surface of the pin section includes a plurality of threads.

In addition to one or more of the features described herein the pin includes a first end joined with the sleeve section and a second end that is cantilevered from the sleeve section.

In addition to one or more of the features described herein the sleeve section includes a first end portion joined to the base section and a second end portion joined to the pin section, the sleeve section including an outer annular surface portion having a second diameter that is greater than the first diameter.

In addition to one or more of the features described herein the base section, sleeve section, and pin section are integrally formed.

In addition to one or more of the features described herein the base section, sleeve section, and pin section are formed from metal.

A vehicle, in accordance with a non-limiting example, includes a body defining a passenger compartment and a component system secured to the body. The component system includes a first component and a second component. The first component includes a post having an outer annular surface and the second component includes an opening that received the pin. A push-on-post fastener is secured to the outer surface of the post. The push-on-post fastener includes a base section and a sleeve section connected with the base section. The sleeve section includes a central passage having an inner surface. The pin extends into the passage. A pin section projects outwardly from the sleeve section through the opening in the second component. The pin section includes an outer annular surface section having a first diameter, wherein the inner surface of the central passage includes a plurality of striations that engage the outer annular surface of the pin.

In addition to one or more of the features described herein the outer annular surface section of the pin section includes a plurality of threads.

In addition to one or more of the features described herein the second component is joined to the first component with a fastener engaging the plurality of threads on the pin section.

In addition to one or more of the features described herein the pin section includes a first end joined with the sleeve section and a second end that is cantilevered from the sleeve section.

In addition to one or more of the features described herein the sleeve section includes a first end portion joined to the base and a second end portion joined to the pin section, the sleeve section including an outer annular surface portion having a second diameter that is greater than the first diameter.

In addition to one or more of the features described herein the base section, the sleeve section, and the pin section are integrally formed.

In addition to one or more of the features described herein the base section, the sleeve section, and the pin section are formed from metal.

In addition to one or more of the features described herein the outer annular surface of the post is smooth.

A method off fastening vehicle components, in accordance with a non-limiting example, includes pushing a sleeve section of a push-on-post fastener over a post on a first vehicle component, securing the push-on-post fastener to the post, positioning a second vehicle component having an opening over the first vehicle component, passing a pin section of push-on-post fastener through the opening, and engaging a fastener onto the pin section of the push-on-post fastener to secure the first vehicle component to the second vehicle component.

In addition to one or more of the features described herein securing the push-on-post fastener to the post includes engaging a plurality of striations formed on an inner surface of the sleeve section with an outer surface of the post.

In addition to one or more of the features described herein engaging the fastener onto the pin section of the push-on-post fastener includes threading the fastener onto threads formed on the pin section.

In addition to one or more of the features described herein also includes determining that a failure exists in the push-on-post fastener, removing the push-on-post fastener from the post, and attaching a new push-on-post fastener to the post to re-secure the first vehicle component with the second vehicle component.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a push-on-post fastener, in accordance with a non-limiting example;

FIG. 2 is a perspective view of a component system including a push-on-post fastener, in accordance with a non-limiting example;

FIG. 3 is a disassembled view of the component system of FIG. 2, in accordance with a non-limiting example;

FIG. 4 is a cross-sectional view of the component system of FIG. 2 taken through the line 4-4 of FIG. 3, in accordance with a non-limiting example;

FIG. 5 is a perspective view of the push-on-post fastener of FIG. 2, in accordance with a non-limiting example;

FIG. 6 is a lower perspective view of the push-on-post fastener of FIG. 5, in accordance with a non-limiting example; and

FIG. 7 is a cross-sectional view of the push-on post fastener of FIG. 5 taken through the line 7-7, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

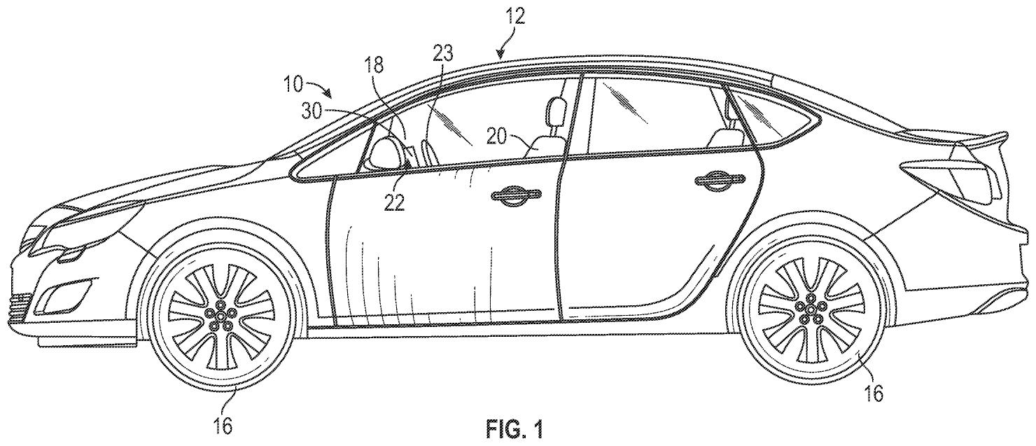

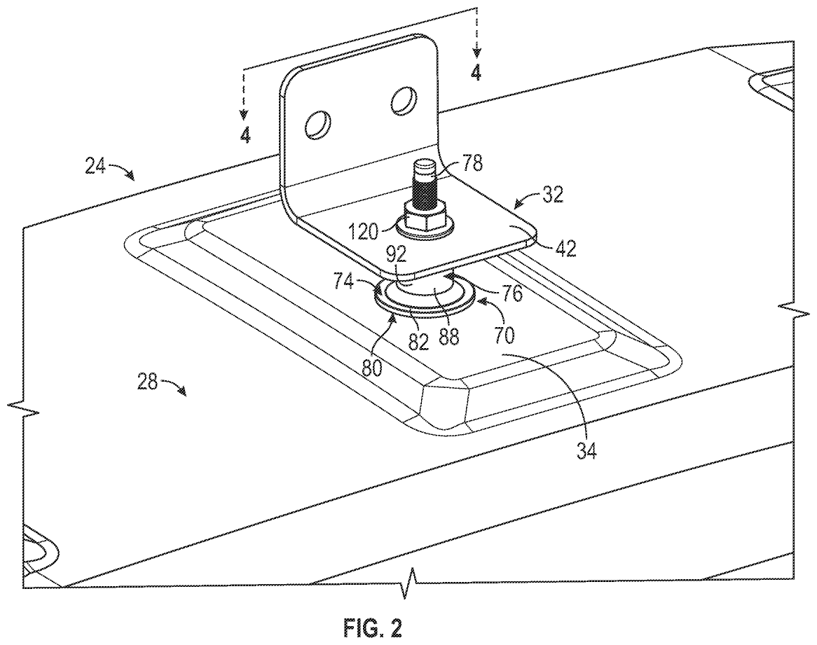

A vehicle, in accordance with a non-limiting example, is indicated generally at 10 in FIG. 1. Vehicle 10 includes a body 12 supported on a plurality of wheels 16. Body 12 includes a passenger compartment 18 within which are arranged a number of seats, such as indicated at 20. Seat 20 is positioned behind a dashboard 22. A steering wheel 23 is arranged between seat 20 and dashboard 22. Dashboard 22 is formed from a component system including multiple connected components. The components may include base materials such as a first component or trim support 28, FIG. 2, an exterior component or exterior decorative trim piece 30, and a second component or interface member 32, FIG. 2.

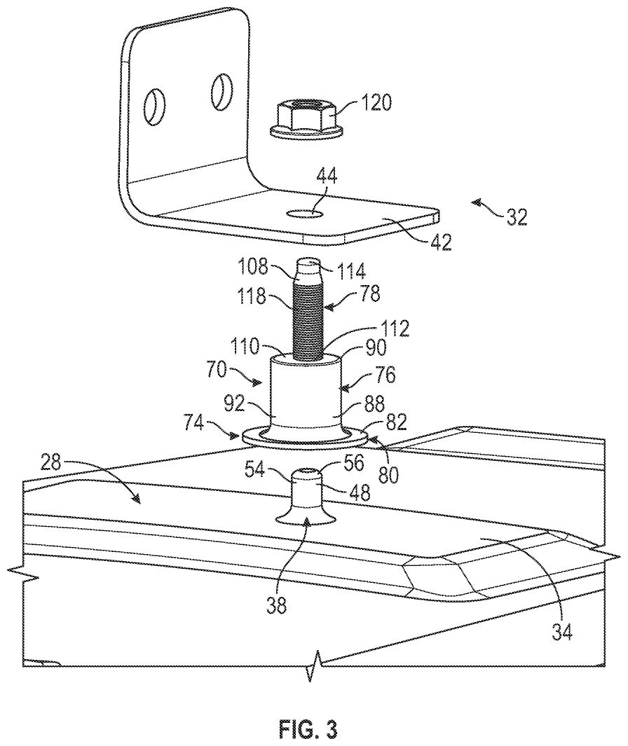

At this point it should be understood that while shown and described in terms of a trim support and a trim piece, the first and second components of the component system may take on a wide variety of forms and need not be limited to dashboard 22 or components for automotive use. In a non-limiting example, first component 28 includes a first surface 34 supporting a plurality of posts, one of which is indicated at 38, FIG. 3. Post 38 projects outwardly from first surface 34. Second component 32 includes a second surface 42 including a plurality of openings, one of which is indicated at 44, FIG. 3.

The plurality of openings 44 may align with one or more of the plurality of posts 38. In a non-limiting example, shown in FIG. 3, each post 38 includes an outer annular surface 48 that is substantially smooth. Each post 38 may include an annular groove 54 that may support a seal 56. In a non-limiting example, post 38 supports a push-on-post (POP) fastener 70 that extends through a corresponding one of the plurality of openings 44 to secure first component 28 to second component 32 as will be described herein.

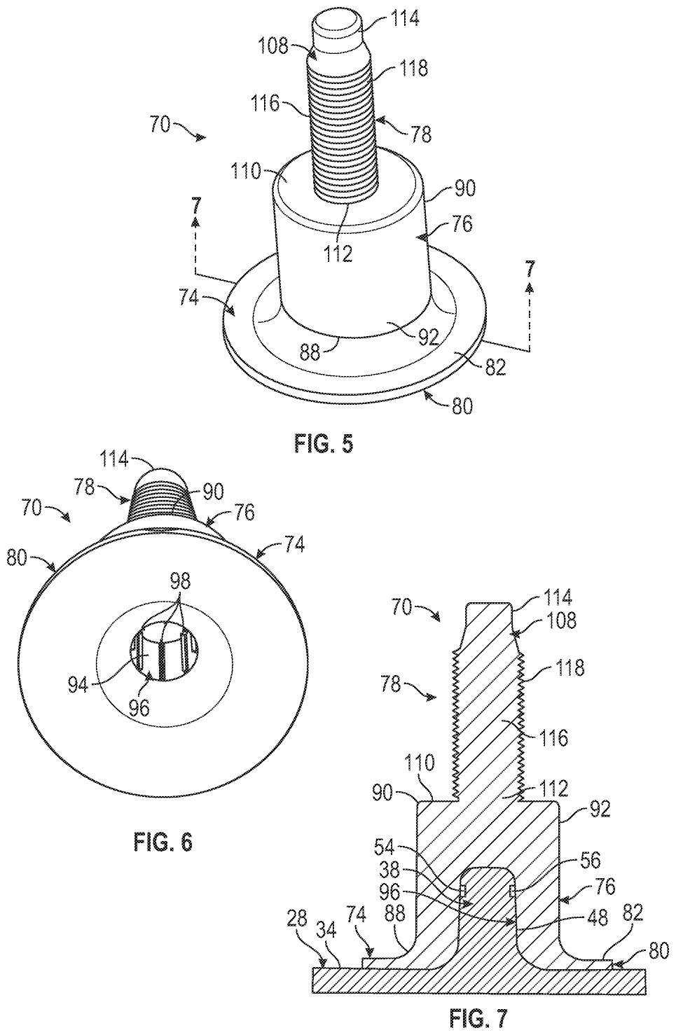

In a non-limiting example shown in FIGS. 3, 4, and 5, POP fastener 70 includes a base section 74, a sleeve section 76, and a pin section 78. Base section 74, sleeve section 76, and pin section 78 are connected. In one non-limiting example, base section 74, sleeve section 76, and pin section 78 form a member having a one-piece construction. Base section 74 includes an annular rim 80 defining a base surface 82. Sleeve section 76 includes a first end portion 88, a second end portion 90. Sleeve section 76 includes an outer annular surface portion 92 and an inner annular surface portion 94 as shown in FIG. 6.

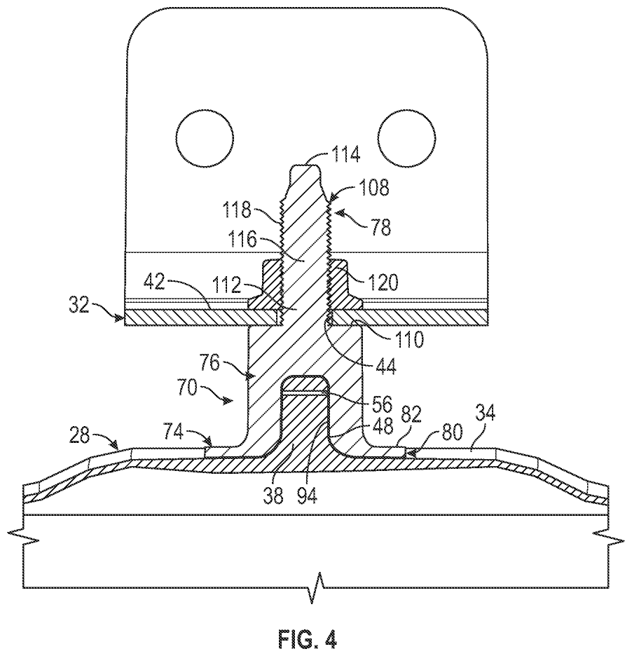

In a non-limiting example, inner annular surface portion 94 defines a central passage 96. A plurality of striations 98 project from inner annular surface portion into central passage 96. As will be detailed herein, striations 98 “bite” into outer annular surface 48 of post 38 when sleeve section 76 is placed over and engaged with post 38 as shown in FIGS. 4 and 7. That is, POP fastener 70 is connected to first component 28 by inserting post 38 into central passage 96 such that striations 98 bite into and engage with outer annular surface 48. Once installed, pin section 78 may pass through the corresponding ones of plurality of openings 44 as will be detailed herein.

In a non-limiting example, pin section 78 includes an outer annular surface section 108 having a first diameter and outer annular surface portion 92 of sleeve section 76 includes a second diameter. In the non-limiting example shown, the first diameter is smaller than the second diameter. In this manner, sleeve section 76 includes a shoulder 110 that may serve as a localized support surface for second component 32. In a non-limiting example, pin section 78 includes a first end 112 extending from shoulder 110 of sleeve section 76, a second end 114, and an intermediate portion 116. Intermediate portion 116 extends between first end 112 and second end 114. Second end 114 is cantilevered from shoulder 110.

A plurality of threads 118 are formed in intermediate portion 116. Threads 118 may be engaged by a threaded fastener 120 such as a nut, a sleeve, a post, or the like used to secure second component 32 to first component 28 with threaded fastener 120. At this point it should be understood that POP fastener 70 provides an easy to manufacture, cost effective alternative to machining pins directly on a component.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A push-on-post fastener comprising:
a base section;
a sleeve section connected with the base section, the sleeve section including a central passage having an inner surface; and
a pin section projecting outwardly from the sleeve section, the pin section including an outer annular surface section having a first diameter, wherein the inner surface of the central passage includes a plurality of striations.

2. The push-on-post fastener according to claim 1, wherein the outer annular surface section of the pin section includes a plurality of threads.

3. The push-on-post fastener according to claim 1, wherein the pin section includes a first end joined with the sleeve section and a second end that is cantilevered from the sleeve section.

4. The push-on-post fastener according to claim 3, wherein the sleeve section includes a first end portion joined to the base section and a second end portion joined to the pin section, the sleeve section including an outer annular surface portion having a second diameter that is greater than the first diameter.

5. The push-on-post fastener according to claim 1, wherein the base section, the sleeve section, and the pin section are integrally formed.

6. The push-on-post fastener according to claim 1, wherein the base section, the sleeve section, and the pin section are formed from metal.

7. A vehicle comprising:
a body defining a passenger compartment;
a component system secured to the body, the component system including a first component and a second component, the first component including a post having an outer annular surface and the second component includes an opening that receives the post; and
a push-on-post fastener secured to the outer annular surface of the post, the push-on-post fastener comprising:
a base section;
a sleeve section connected with the base section, the sleeve section including a central passage having an inner surface, the post extending into the passage; and
a pin section projecting outwardly from the sleeve section through the opening in the second component, the pin section including an outer annular surface section having a first diameter, wherein the inner surface of the central passage includes a plurality of striations that engage the outer annular surface of the post.

8. The vehicle according to claim 7, wherein the outer annular surface section of the pin section includes a plurality of threads.

9. The vehicle according to claim 8, wherein the second component is joined to the first component with a fastener engaging the plurality of threads on the pin section.

10. The vehicle according to claim 7, wherein the pin section includes a first end joined with the sleeve section and a second end that is cantilevered from the sleeve section.

11. The vehicle according to claim 10, wherein the sleeve section includes a first end portion joined to the base section and a second end portion joined to the pin section, the sleeve section including an outer annular surface portion having a second diameter that is greater than the first diameter.

12. The vehicle according to claim 7, wherein the base section, the sleeve section, and the pin section are integrally formed.

13. The vehicle according to claim 7, wherein the base section, the sleeve section, and the pin section are formed from metal.

14. The vehicle according to claim 7, wherein the outer annular surface of the post is smooth.

15. A method of fastening vehicle components comprising:
pushing a sleeve section of a push-on-post fastener over a post on a first vehicle component;
securing the push-on-post fastener to the post;
positioning a second vehicle component having an opening over the first vehicle component;
passing a pin section of push-on-post fastener through the opening; and
engaging a fastener onto the pin section of the push-on-post fastener to secure the first vehicle component to the second vehicle component.

16. The method of claim 15, wherein securing the push-on-post fastener to the post includes engaging a plurality of striations formed on an inner surface of the sleeve section with an outer surface of the post.

17. The method of claim 15, wherein engaging the fastener onto the pin section of the push-on-post fastener includes threading the fastener onto threads formed on the pin section.

18. The method of claim 15, further comprising:
determining that a failure exists in the push-on-post fastener;
removing the push-on-post fastener from the post; and
attaching a new push-on-post fastener to the post to re-secure the first vehicle component with the second vehicle component.
